(19) United States
(12) Patent Application Publication
(10) Pub. No.: US 2025/0206579 A1
(43) Pub. Date: Jun. 26, 2025

(54) CRANE

(71) Applicant: SUMITOMO HEAVY INDUSTRIES, LTD., Tokyo (JP)

(72) Inventors: Yasuhiro YAMAMOTO, Yokosuka-shi (JP); Chunnan WU, Yokosuka-shi (JP); Keita NAKAMORI, Yokosuka-shi (JP); Hisashi OSUMI, Tokyo (JP)

(21) Appl. No.: 18/984,903

(22) Filed: Dec. 17, 2024

(30) Foreign Application Priority Data
Dec. 22, 2023 (JP) 2023-216779

(51) Int. Cl. B66C 13/46; B66C 13/06

(52) U.S. Cl. CPC B66C 13/46; B66C 13/063

(57) ABSTRACT

A crane includes a boom, a camera that is supported by the boom and that images a region including a suspended load, a posture sensor that detects a posture of the camera, and an output unit that outputs a determination result of whether or not to perform an anti-swing operation of the suspended load based on video data acquired by the camera and on detection information of the posture sensor.

### CROSS-REFERENCE TO RELATED APPLICATIONS

This application claims priority to Japanese Patent Application No. 2023-216779, filed on Dec. 22, 2023, which is incorporated by reference herein in its entirety.

### BACKGROUND

### Technical Field

A certain embodiment of the present invention relates to a crane.

### Description of Related Art

The related art discloses a crane in which a sensor unit is attached to a tip part of a boom via a gimbal. A camera and an inertial measurement device are mounted in the sensor unit.

### SUMMARY

According to an embodiment of the present invention, there is provided a crane including: a boom; a camera that is supported by the boom and that images a region including a suspended load; a posture sensor that detects a posture of the camera; and an output unit that outputs a determination result of whether or not to perform an anti-swing operation of the suspended load based on video data acquired by the camera and on detection information of the posture sensor.

According to another embodiment of the present invention, there is provided a crane including: a boom; a camera that is supported by the boom and that images a region including a suspended load; a posture sensor that detects a posture of the camera; and a control unit that executes an anti-swing operation of the suspended load based on video data acquired by the camera and on detection information of the posture sensor.

According to still another embodiment of the present invention, there is provided a crane including: a boom; a camera that is supported by the boom and that images a region including a suspended load; a posture sensor that detects a posture of the camera; and a display unit that outputs a video captured by the camera, in which the display unit corrects a reference point of the video based on information detected by the posture sensor, and the reference point is a point associated with a center of a swing of the suspended load.

### BRIEF DESCRIPTION OF THE DRAWINGS

FIG. 1 is a view showing a crane according to one embodiment of the present invention.

FIG. 2 is an enlarged side view of a portion of a camera unit of FIG. 1.

FIG. 3 is a block diagram showing a control configuration of the crane of FIG. 1.

FIG. 4 is a flowchart showing control processing of an anti-swing operation via automatic control executed by a control unit.

FIG. 5 is a flowchart showing control processing for the crane executed by the control unit.

FIG. 6 is a flowchart showing display control processing executed by the control unit.

FIGS. 7A and 7B show an output example of a display unit via the display control processing of FIG. 6, FIG. 7A is an image diagram when a camera is in a reference posture, and FIG. 7B is an image diagram when the camera is in a posture deviating from the reference posture, such as when a boom is twisted.

### DETAILED DESCRIPTION

In the crane in the related art, there is a case where a posture of the camera is changed or swings when the boom is twisted. It is not possible to accurately detect what kind of swing occurs in a suspended load from a video of the suspended load captured by the camera. Therefore, there is a case where anti-swing control cannot be properly performed.

It is desirable to provide a crane that can more accurately perform anti-swing control of a suspended load.

Hereinafter, each embodiment of the present invention will be described in detail with reference to the drawings.

### One Embodiment

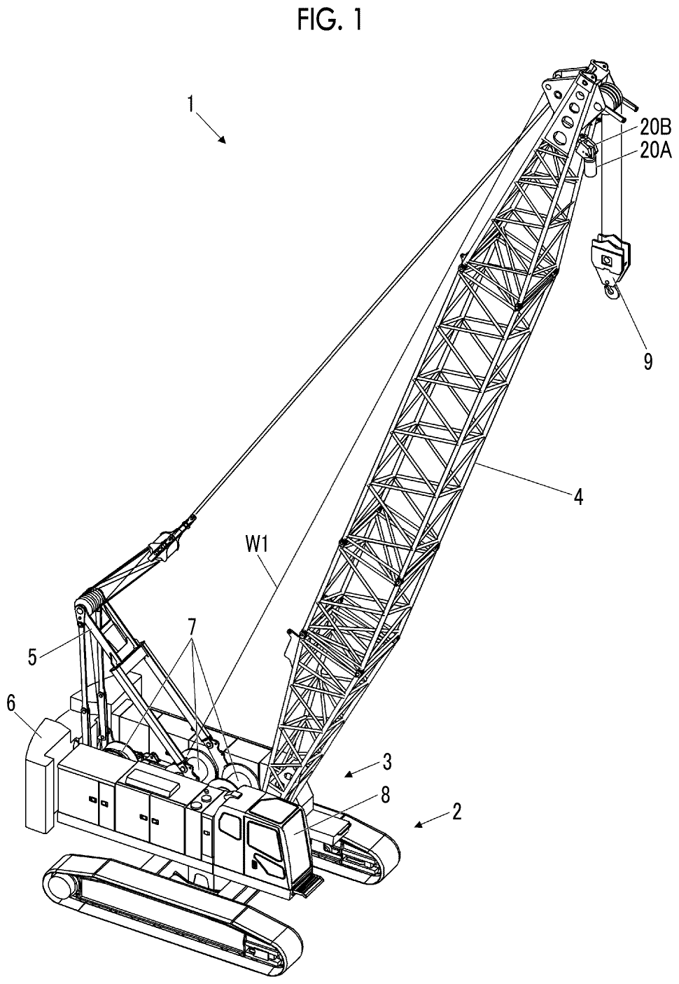

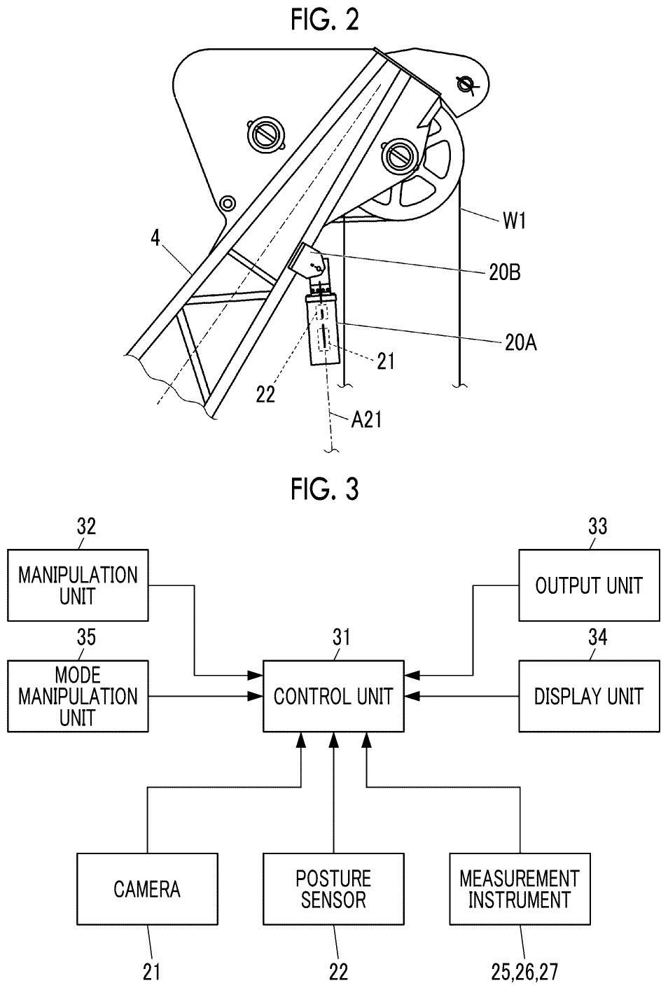

FIG. 1 is a view showing a crane according to one embodiment of the present invention. FIG. 2 is an enlarged side view of a portion of a camera unit of FIG. 1.

A crane 1 according to one embodiment is a mobile crane such as a crawler crane. The crane 1 includes a lower traveling body 2 capable of self-traveling, a rotating platform 3 supported by the lower traveling body 2 to be capable of turning, a boom 4 attached to the rotating platform 3 to be capable of being derricked, a mast 5 that supports the boom 4, and a counterweight 6 mounted to a rear part of the rotating platform 3. A winch 7 that winds and unwinds a wire rope W1 and a cab 8 in which an operator operates are provided on the rotating platform 3. A suspender 9 that is engaged with a suspended load is suspended from a tip of the boom 4 via the wire rope W1. The operator is considered as an example of an operator according to the embodiment of the present invention.

A camera 21 that is supported by the boom 4 and that images a region including the suspended load, and a posture sensor 22 that detects a posture of the camera 21 are provided in a tip part of the boom 4. The tip part means a tip side part of the boom 4 that is divided into three equal parts in a longitudinal direction. The camera 21 and the posture sensor 22 are pivotably fixed to the boom 4. The region including the suspended load means a region including the suspender 9 when the suspended load is not suspended. The camera 21 may be fixed to the boom 4 in a state where the camera 21 cannot be pivoted.

As shown in FIG. 2, the camera 21 and the posture sensor 22 are mounted on a support base 20A, such as a casing or a bracket, and are unitized. That is, the camera 21 and the posture sensor 22 are attached to one support base 20A in a state where the camera 21 and the posture sensor 22 are not displaced relative to each other. Therefore, a posture of the posture sensor 22 corresponds to a posture of the camera 21, and the posture detected by the posture sensor 22 represents the posture of the camera 21.

The support base 20A is attached to the boom 4 via a support frame 20B that pivotably supports the support base 20A. The support frame 20B is pivotable about one rotation axis, and the rotation axis of the support frame 20B is parallel to a center axis of a derricking motion of the boom 4. With such a configuration, even when a derricking angle of the boom 4 is changed from a state close to horizontal to a state close to vertical, the support base 20A can be directed downward from the tip part of the boom 4 by using the dead weight. As the pivotable configuration of the support frame 20B, a notch mechanism may be provided such that a position is semi-fixed at a plurality of pivot angles. The notch mechanism applies a fixing effect to such an extent that the rotation of the support base 20A having a supported configuration due to the dead weight is not hindered. With this configuration, the support base 20A can be pivoted with the derricking of the boom 4, while a swing of the support base 20A can be reduced with respect to the support frame 20B due to weak wind or the like.

The support base 20A is not limited to having a configuration in which the support base 20A is pivoted with respect to the support frame 20B by using the dead weight, and may be configured to, for example, pivot actively using an actuator such that a field of view of the camera 21 faces a direction of the suspended load. In addition, a pivoting mechanism of the support base 20A is not limited to a mechanism that pivots about one axis, and, for example, various mechanisms may be adopted, such as a two-axis pivoting mechanism having two pivoting axes and a mechanism that can pivot at various angles via a universal joint.

The posture sensor 22 is a sensor for detecting the posture of the camera 21, and is, for example, an inertial measurement unit (IMU). The posture means tilt angles (for example, a roll angle, a pitch angle, and a yaw angle) in three axial directions of the camera 21. The three axes mean three axes perpendicular to each other. The posture sensor 22 can measure the tilt angles in the three axial directions (for example, the roll angle, the pitch angle, and the yaw angle) from a reference posture in a case where a posture at an arbitrary reference point in time is set as the reference posture, by detecting the acceleration in the three axial directions, a gravity direction at rest (a vertical direction), and an angular velocity in a three-dimensional direction. The posture sensor 22 is not limited to this, and other sensors may be used as long as the sensor can detect the posture. For example, the posture sensor 22 may be a sensor further including a geomagnetic sensor, or may be a sensor including only a tilt angle sensor.

With the above-described configuration of the posture sensor 22, for example, the posture sensor 22 can measure the tilt angles in the three axial directions with the reference posture when the boom 4 is at a predetermined angle, to obtain the posture of the posture sensor 22 regardless of how a position and an angle of the boom 4 are changed and how a direction of the support base 20A is changed with respect to the support frame 20B. By comparing the posture of the boom 4 with the posture of the posture sensor 22, it is possible to obtain the tilt angle of the posture sensor 22 relative to the boom 4. The posture of the boom 4 can be obtained from a value of a measurement instrument 25 for the derricking angle provided in a derricking mechanism of the boom 4 and a value of a measurement instrument 26 for a turning angle provided in a turning mechanism of the rotating platform 3. The measurement instrument 25 for the derricking angle and the measurement instrument 26 for the turning angle are not limited to those described above as long as the respective angles can be measured, and a posture sensor similar to the posture sensor 22 may be fixed to the boom 4, to obtain the angle of the boom 4 based on an output of the posture sensor.

The posture sensor 22 is disposed on the same straight line as an optical axis A21 (see FIG. 2) of the camera 21. An extension line of the optical axis A21 is indicated by a thick chain line. With such a configuration, the calculation is facilitated when the tilt angle of the camera 21 or the tilt angle of the camera 21 with respect to the boom 4 is calculated from the output of the posture sensor 22. In particular, since a change in an error is small regardless of the posture, the error in the tilt angle is small. The posture sensor 22 is disposed on the same straight line as the optical axis A21 and on a side opposite to an imaging direction of the camera 21. With such a configuration, the posture sensor 22 can be disposed on the same straight line as the optical axis A21 of the camera 21 without hindering the imaging of the camera 21.

FIG. 3 is a block diagram showing a control configuration of the crane in FIG. 1. The crane 1 includes a control unit 31 that performs control of operation assistance, a manipulation unit 32 that is manipulated by the operator to perform a manipulation, an output unit 33 that notifies the operator via display, voice, or both display and voice, a display unit 34 that displays the suspended load, and a mode manipulation unit 35 that is capable of switching an operation mode to an anti-swing mode. The manipulation unit 32, the output unit 33, the display unit 34, and the mode manipulation unit 35 are disposed inside the cab 8, but, in a configuration in which the crane 1 is remotely controlled, the manipulation unit 32, the output unit 33, the display unit 34, and the mode manipulation unit 35 may be disposed in a remote control room away from the crane 1. The output unit 33 and the display unit 34 may be provided outside the cab 8.

The control unit 31 is a computer that operates in accordance with a control program. The outputs of the camera 21, the posture sensor 22, the measurement instruments 25 and 26 that measure the turning angle and the derricking angle of the boom 4, and a measurement instrument 27 that measures an unwinding amount of the wire rope W1 are transmitted to the control unit 31. The wire rope W1 is for suspending the suspended load, and a suspending length of the suspended load can be calculated from the unwinding amount of the wire rope W1. A manipulation signal of the mode manipulation unit 35, video data of the camera 21, and detection information of the posture sensor 22 are transmitted to the control unit 31. The control unit 31 can output notification information from the output unit 33 and transmit display data to the display unit 34 to perform display outputs of the video and an image via the display unit 34. In addition, the control unit 31 can output a command to a drive mechanism of the crane 1 to turn and derrick the boom 4 and to raise or lower the suspended load.

The control unit 31 can accurately calculate a position within the field of view of the camera 21, at which the reference position of the suspended load that is the position of the suspended load when there is no swing of the suspended load is located, based on the detection information of the posture sensor 22 (that is, posture information of the camera 21), the turning angle of the boom 4, the derricking angle of the boom 4, and the unwinding amount of the wire rope W1 that suspends the load. In addition, from the above-described information, the control unit 31 can accurately calculate which direction within the field of view of the camera 21 is a turning direction (that is, a direction in which the suspended load moves due to the turning) and which direction is a derricking direction (that is, a direction in which the suspended load moves due to the derricking).

The control unit 31 can further switch the operation mode of the crane 1. The operation mode includes a normal mode in which the operator performs control and the anti-swing mode in which the swing of the suspended load is reduced by automatic control.

### Anti-Swing Operation Via Automatic Control

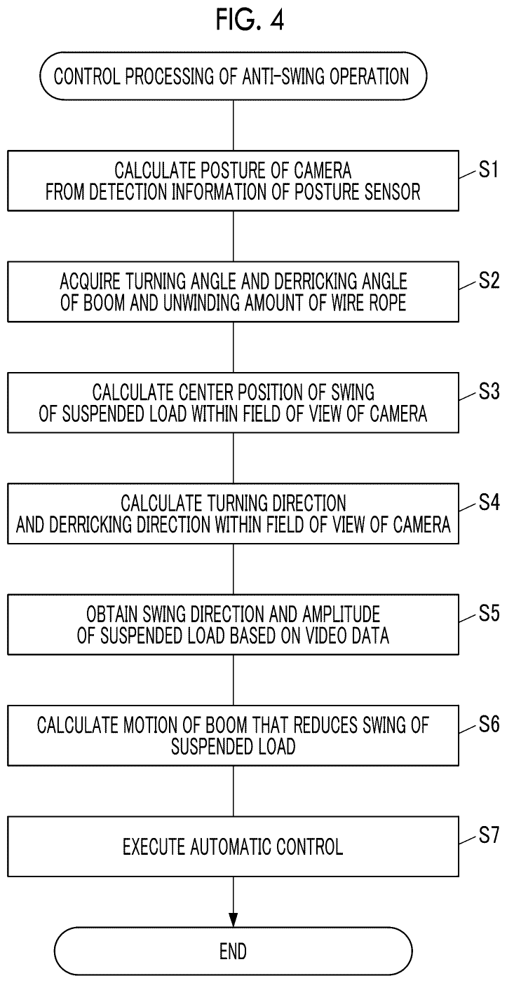

FIG. 4 is a flowchart showing control processing of an anti-swing operation via automatic control executed by the control unit. The control processing is started by the control unit 31 when the transition to the anti-swing mode is performed. The anti-swing operation includes an operation of not only completely stopping the swing but also suppressing the swing.

When the transition to the anti-swing mode is performed, the control unit 31 calculates the posture of the camera 21 from the detection information of the posture sensor 22 (step S1). Further, the control unit 31 acquires measurement information on the turning angle and the derricking angle of the boom 4 and information on the unwinding amount of the wire rope W1 (step S2). Then, based on the information of steps S1 and S2, it is calculated which position within the field of view of the camera 21 is a center position of the swing of the suspended load (a position of the center of the suspended load when there is no swing of the suspended load) (step S3). Further, the control unit 31 calculates the turning direction and the derricking direction of the boom 4 within the field of view of the camera 21 based on the information of steps S1 and S2 (step S4).

Subsequently, the control unit 31 performs image analysis based on the video data of the camera 21 to obtain a swing direction and an amplitude of the suspended load (step S5), and calculates the motion of the boom 4 that reduces the swing (step S6). The motion of the boom 4 is, for example, a motion of displacing the boom 4 by a short distance in the same direction as the swing of the suspended load, but various motions may be applied as long as the swing of the suspended load can be reduced. The image analysis of step S5 includes a calculation via machine learning-based artificial intelligence.

The control unit 31 executes a turning operation and a derricking operation (an extension/retraction operation may be performed in an extendable/retractable boom 4) of the boom 4 via the automatic control such that the motion calculated in step S6 occurs (step S7). The operation corresponds to the anti-swing operation of the suspended load via the automatic control. When the automatic control is completed, the control unit 31 ends the anti-swing operation processing. The above-described anti-swing operation is an operation in which an operation amount of the boom 4 is determined based on the video data and on the output (the detection information) of the posture sensor 22.

With the above-described operation processing, the control unit 31 can accurately calculate the direction and the magnitude in which the suspended load swings, based on the detection information of the posture sensor 22 indicating the posture of the camera 21 and on the video data of the camera 21. The control unit 31 performs an operation of displacing the boom 4 to reduce the swing of the suspended load, based on the calculation result. Therefore, it is possible to efficiently reduce the swing of the suspended load (for example, in a short time and with a small displacement of the boom 4).

The anti-swing operation processing via the automatic control of the control unit 31 is not limited to being started based on the manipulation by the operator for the operation mode. For example, the above-described operation processing may be automatically executed during the following operation. That is, for example, the control unit 31 may automatically start the anti-swing operation processing in the vicinity of a transport end point during a period in which the manipulation of transporting the suspended load via the operation of the operator is performed. Even in such an anti-swing operation processing, the control unit 31 calculates the direction and the magnitude in which the suspended load swings, based on an accurate measurement result of the posture of the camera 21 and the video data of the camera 21, and performs the operation of displacing the boom 4, based on the calculation result. Therefore, the automatic operation of reducing the swing via the control unit 31 functions effectively, and thus the swing of the suspended load can be efficiently and stably reduced.

### Control Processing

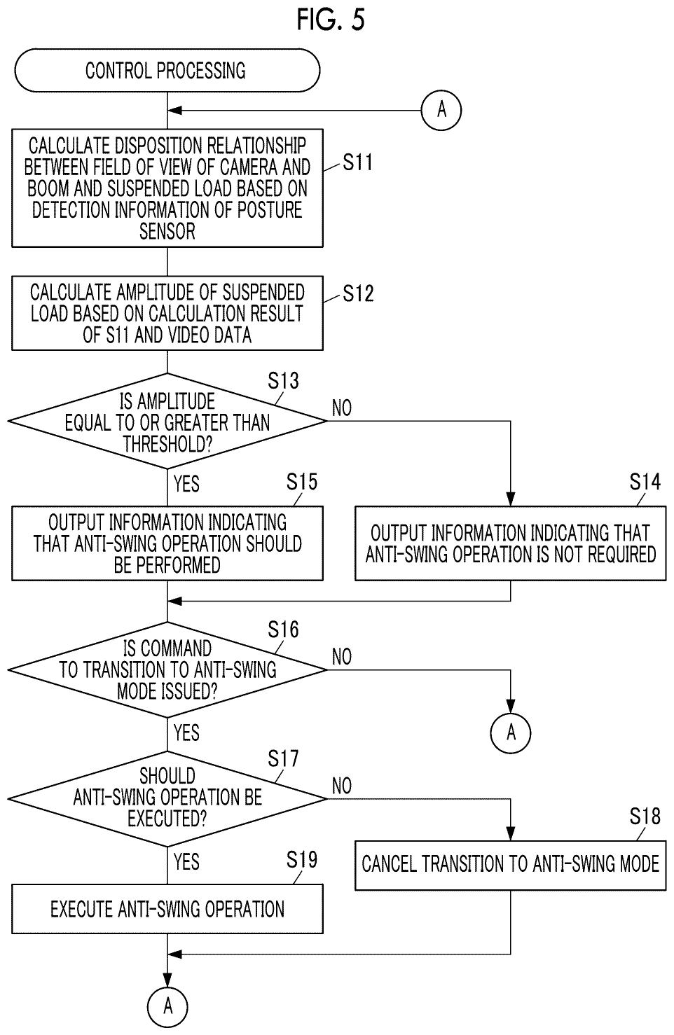

FIG. 5 is a flowchart showing control processing of the crane executed by the control unit. The control processing is started when the control unit 31 is started. When the control processing is started, the control unit 31 calculates a disposition relationship between the field of view of the camera 21 and the boom 4 and the suspended load from the detection information of the posture sensor 22, the turning angle and the derricking angle of the boom 4, and the unwinding amount of the wire rope W1. The control unit 31 calculates which position in the video of the camera 21 is the center of the swing of the suspended load (step S11). Further, in step S11, the control unit 31 also calculates which direction is the turning direction and the derricking direction of the boom 4. Here, since the calculation is performed based on the posture information indicating the posture of the camera 21, even when the boom 4 is twisted or swings, the calculation result is more accurate.

Subsequently, the control unit 31 obtains the amplitude of the suspended load by obtaining the position and a displacement speed of the suspended load by performing the image analysis on the video data of the camera 21, to perform a calculation in combination with the calculation result of step S11 (step S12). Here, since the center position of the swing of the suspended load is accurately obtained by the processing of step S11, the amplitude can be accurately obtained. The above-described image analysis includes a calculation via machine learning-based artificial intelligence.

Then, the control unit 31 determines whether or not the amplitude is equal to or greater than a threshold (step S13). When the result of the determination is NO, the control unit 31 outputs the notification information indicating that the anti-swing operation of the suspended load is not necessary, via the output unit 33 (step S14). On the other hand, when the result of the determination of step S12 is YES, the control unit 31 outputs information indicating that the anti-swing operation of the suspended load should be performed, via the output unit 33 (step S15). The outputs of steps S14 and S15 may be information display output (character display, color display such as warning color or standard color, presence or absence of a predetermined display mode of a warning light, and the like), or may be audio output from a speaker.

The operator can determine whether or not to perform the anti-swing operation of the suspended load, based on the notification outputs of steps S14 and S15. For example, in a case where information indicating that the anti-swing operation should be performed is output, the operator can perform the anti-swing operation of the suspended load and reduce the swing of the suspended load. On the other hand, in a case where the information indicating that the anti-swing operation is not necessary is output, the operator can continue a suspended load transport operation without performing the anti-swing operation of the suspended load. Therefore, the operator can implement efficient suspended load transport processing.

In the above-described example, the configuration has been described in which the control unit 31 determines whether or not to perform the anti-swing operation, based on the amplitude of the suspended load. However, the determination of whether or not to perform the anti-swing operation may be performed by taking various pieces of information into account, such as the swing direction of the suspended load (such as the derricking direction or the turning direction), a relative positional relationship between a structure located therearound and the suspended load (whether or not the swing causes the suspended load to approach the structure), and a load ratio of the suspended load (how close a current load is to a limited load).

Subsequently, the control unit 31 determines whether or not a command to transition to the anti-swing mode is input via the mode manipulation unit 35 (step S16). Then, when the transition command is issued, the control unit 31 performs the same determination as in step S13 (step S17), and cancels, when it is determined that the anti-swing operation is not necessary, the transition to the anti-swing mode (step S18). In this case, the control unit 31 may perform display or notification of the fact that the transition to the anti-swing mode is canceled, to the operator, via voice. With the processing of step S18, it is possible to give an opportunity to reconsider when the operator tries to perform unnecessary anti-swing control. On the other hand, when it is determined that the anti-swing control should be performed, the control unit 31 executes the anti-swing operation via the automatic control (step S19).

When no command to transition to the anti-swing mode is issued, the automatic control is canceled, or the anti-swing operation via the automatic control is completed, the control unit 31 repeats the processing from step S11 again.

With the above-described control processing, the operator can determine whether or not to perform the anti-swing operation, based on the accurate measurement result of the swing of the suspended load, and can implement the necessary anti-swing operation based on the determination. Therefore, even the operator with a low level of skill can operate the crane 1 more efficiently and more stably.

### Display Control Processing

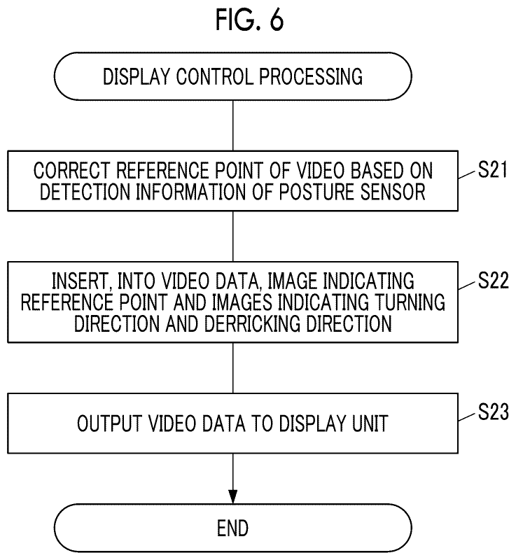

FIG. 6 is a flowchart showing display control processing executed by the control unit. The display control processing is repeatedly executed while the crane 1 is being driven. When the display control processing is started, the control unit 31 calculates the disposition relationship between the field of view of the camera 21 and the boom 4 and the suspended load from the detection information of the posture sensor 22, the turning angle and the derricking angle of the boom 4, and the unwinding amount of the wire rope W1. Then, the control unit 31 corrects the reference point of the video based on the above-described disposition relationship (step S21).

The reference point is a point associated with the center of the swing of the suspended load, and, specifically, is a center point of the swing of the suspended load. The center point of the swing is a point when the suspended load is vertically lowered from the tip of the boom 4. The reference point is not limited to the center point of the swing, and may be, for example, the origin “X=0, Y=0” when the center point of the swing is set to a predetermined value “X=X0, Y=Y0” (here, X is an X-axis coordinate in the video, and Y is a Y-axis coordinate in the video). That is, the reference point need only be any point associated with the center point of the swing such that the center point of the swing can be known from the reference point. The correction of the reference point includes a correction in at least two axes, the X axis and the Y axis.

In step S21, in order to correct the reference point, the control unit 31 calculates which position in the video of the camera 21 is the center of the swing of the suspended load, from the disposition relationship between the field of view of the camera 21 and the boom 4 and the suspended load. Further, in step S21, the control unit 31 may also calculate which direction in the video is the turning direction and the derricking direction of the boom 4. Then, a difference between the center of the swing of the suspended load in a standard state and the calculated center of the swing is added to the reference point in a standard time, to correct the reference point. Here, the standard state need only be determined in advance as a state where the disposition relationship between the boom, the camera, and the suspended load is an arbitrary relationship.

Since the calculation is performed in step S21 based on the posture information indicating the posture of the camera 21, even when the boom 4 is twisted or the like, an accurate disposition relationship between the boom 4 and the camera 21 can be calculated, and thus the calculation result of the reference point is also accurate.

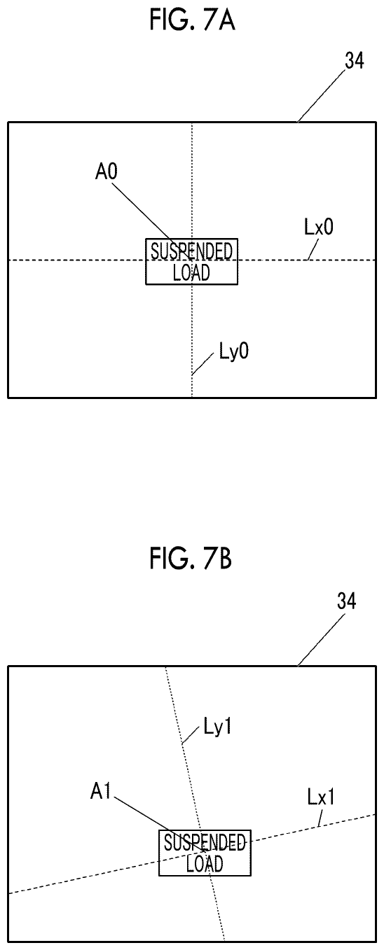

Next, the control unit 31 inserts, into the video data of the camera 21, an image indicating the center of the swing of the suspended load as the reference point (see intersection points A0 and A1 in FIGS. 7A and 7B), an image indicating the turning direction (the direction in which the suspended load moves due to the turning of the rotating platform 3) (see scale lines Lx0 and Lx1 in FIGS. 7A and 7B), and an image indicating the derricking direction (the direction in which the suspended load moves due to the derricking of the boom 4) (see scale lines Ly0 and Ly1 in FIGS. 7A and 7B) (step S22). Here, the control unit 31 determines an insertion position of each image based on the calculation result of step S21. Then, the display unit 34 outputs the video data into which the image is inserted, to the display unit 34 (step S23).

The control unit 31 repeats the processing of steps S21 to S23 at predetermined time intervals.

FIGS. 7A and 7B show images output from the display unit 34 via the display control processing of FIG. 6, FIG. 7A is an image in the standard state, and FIG. 7B is an image when the boom 4 is twisted and the direction of the camera 21 deviates from the standard state.

In the standard state, for example, as shown in FIG. 7A, an image in which the center of the video is the center (intersection point A0) of the swing of the suspended load, a left-right direction of the video is the turning direction (scale line Lx0), and an up-down direction of the video is the derricking direction (scale line Ly0) is output to the display unit 34.

Meanwhile, in a case where the boom 4 is twisted or the camera 21 deviates, as shown in FIG. 7B, an image in which the center (intersection point A1) of the swing of the suspended load is located outside the center of the video, and the turning direction (scale line Ly1) and the derricking direction (scale line Lx1) are outside the left-right direction and the up-down direction of the video is output to the display unit 34.

In either image, when the suspended load swings, the suspended load swings about the intersection points A0 and A1 in the image. A period of the swing of the suspended load is relatively long, but the video displays the image (intersection points A0 and A1) indicating the center of the swing of the suspended load and the images (scale lines Lx0, Ly0, Lx1, and Ly1) indicating the respective directions. Therefore, the operator can quickly and accurately identify the direction and the magnitude in which the suspended load swings, from the video, without waiting for one period or a half period of the swing. The operator performs the anti-swing operation while viewing the video, so that the swing of the suspended load can be accurately and efficiently reduced. For example, in a case where, unlike in the present embodiment, the intersection points A0 and A1 are not changed in accordance with the center of the swing of the suspended load, the intersection point A0 is always located at the center of the video. In such a configuration, in a case where the posture of the camera 21 is changed due to the twist of the boom 4 or the swing of the camera 21, the operator has difficulty in determining whether or not the suspended load actually swings. However, as in the embodiment of the present application, by displaying the reference of the center of the swing of the suspended load, such as the intersection points A0 and A1, as in the present embodiment, the operator can easily determine whether or not the suspended load actually swings.

In the example of FIGS. 7A and 7B, the example has been described in which the positions of the images (the intersection points A0 and A1 and the scale lines Lx0, Ly0, Lx1, and Ly1) added to the video are changed in accordance with the posture of the camera 21 by correcting the reference point of the video. However, a configuration may be adopted in which a portion of the video is cut out in a frame shape from the video acquired by the camera 21, and the cut-out video is output to a predetermined frame of a screen of the display unit 34. Then, the portion cut out in a frame shape may be changed in accordance with the posture of the camera 21, to correct the reference point of the video. In this case, for example, the video need only be cut out in a frame such that the calculated intersection point A1 is the center on the video and the calculated scale lines Lx1 and Ly1 are in the left-right direction and the up-down direction on the video.

As described above, the crane 1 according to the present embodiment includes the camera 21 that is supported by the boom 4 and that images the region including the suspended load, and the posture sensor 22 that detects the posture of the camera 21. Further, the crane 1 includes the output unit 33 that outputs the determination result of whether or not to perform the anti-swing operation of the suspended load, based on the video data acquired by the camera 21 and on the detection information of the posture sensor 22. In this way, for example, even when the boom 4 is twisted, the direction of the camera 21 deviates from the standard, or the camera 21 swings, an accurate determination result reflecting these cases can be obtained based on the determination result based on the detection information indicating the posture of the camera 21 and on the video data of the camera 21. Therefore, the operator can perform the necessary anti-swing operation based on the determination result. Therefore, even when the operator has a low level of skill, the crane 1 can be efficiently and stably operated.

Further, the crane 1 according to the present embodiment has the anti-swing mode in which the anti-swing operation is performed. Meanwhile, in the crane 1, even in a case where the command to transition to the anti-swing mode is input via the mode manipulation unit 35, when the above-described determination result is negative (see step S18 in FIG. 5), the transition to the anti-swing mode is canceled. Therefore, it is possible to give an opportunity to reconsider when the operator tries to perform unnecessary anti-swing control. Therefore, the crane 1 can be operated more efficiently.

Further, the crane 1 according to the present embodiment includes the control unit 31 that executes the anti-swing operation of the suspended load based on the video data acquired by the camera 21 and on the detection information of the posture sensor 22. For example, even when the boom 4 is twisted, or the direction of the camera 21 deviates from the standard, the anti-swing operation that can effectively reduce the swing of the suspended load by reflecting these cases can be implemented by performing the anti-swing operation based on the detection information indicating the posture of the camera 21 and on the video data of the camera 21. Therefore, the anti-swing operation via the control unit 31 effectively reduces the swing of the suspended load, and even the operator having a low level of skill can efficiently and stably operate the crane 1.

Further, with the crane 1 according to the present embodiment, the reference point of the video output to the display unit 34 is corrected based on the video data acquired by the camera 21 and on the detection information of the posture sensor 22. The reference point is a point associated with the center of the swing of the suspended load. In this way, for example, even when the boom 4 is twisted, or the direction of the camera 21 deviates from the standard, the video reflecting these cases can be output by using the video in which the reference point is corrected based on the detection information indicating the posture of the camera 21. By using the video, the operator or a worker can accurately and quickly identify the magnitude and the direction of the swing of the suspended load. Therefore, the operator or the worker can make a correct determination regarding the swing of the suspended load based on the identification, and can efficiency and stably operate the crane 1.

Further, with the crane 1 according to the present embodiment, the correction of the reference point includes the correction in the two axial directions (for example, the X-axis direction and the Y-axis direction) intersecting each other. Therefore, even in a situation where the camera 21 deviates in the two axial directions, such as when the boom 4 is twisted, the correction of the reference point can be performed by reflecting the situation. Therefore, even in such a situation, the operator or the worker can accurately and promptly identify the magnitude and the direction of the swing of the suspended load by using the video in which the reference point is corrected. The above-described correction may include a correction of the rotation direction in the video, a correction of the scale, or both of these corrections. By such a correction, it is possible to output the video in which the magnitude and the direction of the swing of the suspended load can be more accurately and more quickly identified.

Further, with the crane 1 according to the present embodiment, the camera 21 is fixed to the boom 4. With this configuration, the camera 21 can easily acquire the video in which the swing of the suspended load is easily identified. In the present embodiment, the camera 21 is pivotably fixed to the boom 4, but the camera 21 may be fixed in a non-pivotable state.

Further, with the crane 1 according to the present embodiment, the posture sensor 22 is disposed on the same straight line as the optical axis A21 of the camera 21. Therefore, it is possible to simplify the calculation of obtaining the posture of the camera 21 from the detection information of the posture sensor 22.

The embodiment of the present invention has been described above. However, the present invention is not limited to the above-described embodiment. For example, in the above-described embodiment, the configuration has been described in which all of the control processing of the anti-swing operation via the automatic control, the output processing of the determination result of whether or not to perform the anti-swing operation, and the display processing of correcting the position of the center of the swing of the suspended load are performed in one crane 1, based on the detection information of the posture sensor and on the video data. However, in the crane according to the present invention, among the three pieces of processing, only two pieces of processing or only one piece of processing may be performed. Even in this case, the effect of each processing is exhibited in the crane. In addition, in the above-described embodiment, the example has been described in which the boom 4 is operated such that the swing is suppressed as the anti-swing operation of suppressing the swing of the suspended load, but the anti-swing operation may be implemented by controlling the unwinding and the winding of the wire rope W1, or by adding the control. In addition, the movement of the boom 4 for implementing the anti-swing operation may include the derricking and the turning of the boom 4, and the extension and retraction when the boom is extendable and retractable. In addition, in the above-described embodiment, the intersection point of the scale lines has been described as the reference point of the video, but the reference point of the video may be a dot image, or may be a point indicated by a round image or an arrow image having an appropriate size. The image indicating the reference point in the video may have any form as long as the position of the reference point can be recognized.

In addition, in the above-described embodiment, the mobile crane has been described, but the present invention may be applied to any crane as long as the crane includes the boom for suspending the load. That is, the crane according to the embodiment of the present invention is not limited to the crawler crane, and can be applied to all cranes such as a tower crane, a ceiling crane, a jib crane, a retractable crane, a stacker crane, a portal crane, and an unloader, in addition to other mobile cranes such as a wheel crane, a truck crane, a rough terrain crane, and an all-terrain crane. In addition, the details shown in the embodiment can be modified as appropriate without departing from the scope of the invention.

It should be understood that the invention is not limited to the above-described embodiment, but may be modified into various forms on the basis of the spirit of the invention. Additionally, the modifications are included in the scope of the invention.

What is claimed is:

1. A crane comprising:
a boom;
a camera that is supported by the boom and that images a region including a suspended load;
a posture sensor that detects a posture of the camera; and
an output unit that outputs a determination result of whether or not to perform an anti-swing operation of the suspended load based on video data acquired by the camera and on detection information of the posture sensor.

2. The crane according to claim 1,
wherein, even in a case where a command to transition to an anti-swing mode in which the anti-swing operation is executed is input from a manipulation unit manipulated by an operator, when the determination result is negative, the transition to the anti-swing mode is canceled.

3. A crane comprising:
a boom;
a camera that is supported by the boom and that images a region including a suspended load;
a posture sensor that detects a posture of the camera; and
a control unit that executes an anti-swing operation of the suspended load based on video data acquired by the camera and on detection information of the posture sensor.

4. The crane according to claim 3,
wherein the anti-swing operation is an operation in which an operation amount of the boom is determined based on the video data and on an output of the posture sensor.

5. A crane comprising:
a boom;
a camera that is supported by the boom and that images a region including a suspended load;
a posture sensor that detects a posture of the camera; and
a display unit that outputs a video captured by the camera,
wherein the display unit corrects a reference point of the video based on information detected by the posture sensor, and
the reference point is a point associated with a center of a swing of the suspended load.

6. The crane according to claim 5,
wherein correcting the reference point includes a correction in two axial directions intersecting each other.

7. The crane according to claim 1,
wherein the camera is fixed to the boom.

8. The crane according to claim 7,
wherein the posture sensor is disposed on a same straight line as an optical axis of the camera.

9. The crane according to claim 8,
wherein the camera and the posture sensor are mounted on a support base and are unitized, and
the camera and the posture sensor are mounted on one support base in a state of not being displaced relative to each other.

10. The crane according to claim 9,
wherein the support base is attached to the boom via a support frame that pivotably supports the support base.

11. The crane according to claim 10,
wherein the support frame is pivotable about one rotation axis, and
the rotation axis is parallel to a center axis of a derricking motion of the boom.

12. The crane according to claim 9,
wherein the support base is configured to pivot actively using an actuator such that a field of view of the camera faces a direction of the suspended load.

13. The crane according to claim 1, further comprising:
a lower traveling body;
a rotating platform that turns with respect to the lower traveling body; and
a boom that is attached to the rotating platform to be capable of being derricked,
wherein the camera is configured to turn with respect to the lower traveling body as the rotating platform turns and to be derricked with respect to the rotating platform as the boom is derricked with respect to the rotating platform.
